(19) United States
(12) Patent Application Publication
(10) Pub. No.: US 2024/0306034 A1
(43) Pub. Date: Sep. 12, 2024

(54) BUFFER STATUS REPORTING (BSR) TECHNIQUES

(71) Applicant: ZTE Corporation, Shenzhen (CN)

(72) Inventors: Jiajun XU, Shenzhen (CN); Yuzhou HU, Shenzhen (CN); Mengzhu CHEN, Shenzhen (CN); Jun XU, Shenzhen (CN); Jianqiang DAI, Shenzhen (CN); Xiaoying MA, Shenzhen (CN); Hong TANG, Shenzhen (CN)

(21) Appl. No.: 18/661,358

(22) Filed: May 10, 2024

Related U.S. Application Data
(63) Continuation of application No. PCT/CN2022/074478, filed on Jan. 28, 2022.

(51) Int. Cl. H04W 28/02

(52) U.S. Cl. CPC H04W 28/0278

(57) ABSTRACT

Techniques are described for an indication of a buffer status reporting from multiple types of BSR, selection and/or indication of a buffer size (BS) level table, design of a BS level table, and/or determination of data volume of an uplink shared channel. An example wireless communication method includes transmitting, by a communication device, a buffer status reporting (BSR), wherein the BSR includes an index that indicates a data amount for transmission by the communication device, wherein the index corresponding to the data amount is from a table, and wherein each index in the table is associated with one maximum data amount.

### CROSS-REFERENCE TO RELATED APPLICATION

This application is a continuation and claims priority to International Application No. PCT/CN2022/074478, filed on Jan. 28, 2022, the disclosure of which is hereby incorporated by reference herein in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for indication of a buffer status report (BSR) from multiple types of BSR, selection and/or indication of a buffer size (BS) level table, design of a BS level table, and/or determination of data volume of an uplink shared channel (e.g., physical uplink shared channel (PUSCH)). A buffer size level table can also be a buffer size set or other types.

An example wireless communication method includes transmitting, by a communication device, a buffer status reporting (BSR), wherein the BSR includes an index that indicates a data amount for transmission by the communication device, wherein the index corresponding to the data amount is from a table, and wherein each index in the table is associated with one maximum data amount.

In some embodiments, the BSR or the table is determined by a first indication, wherein the first indication is received by the communication device. In some embodiments, the first indication is carried by a radio resource control (RRC) signaling, a medium access control (MAC) control element (CE) signaling, or a physical (PHY) layer signaling. In some embodiments, the PHY layer signaling includes at least a downlink control information (DCI). In some embodiments, the BSR includes a first BSR, or a second BSR. In some embodiments, the first BSR and/or the second BSR is associated with the table.

In some embodiments, the method further comprises transmitting, by a communication device, a second indication wherein the second indication determines or indicates any one or more of: a type of BSR, a table for BSR, a delta index information, or a scaling factor information. In some embodiments, the second indication is carried by a radio resource control (RRC) signaling, a medium access control (MAC) control element (CE) signaling, a MAC CE header, or a physical (PHY) layer signaling. In some embodiments, the RRC signaling includes any one or more of a user equipment (UE) capability, or UE assistance information. In some embodiments, the MAC CE signaling includes an information of a number of logical channels or a BSR. In some embodiments, the MAC CE header includes any one or more of a logical channel identifier (LCID), an enhanced logical channel identifier (eLCID) in a subheader of MAC protocol data unit (PDU), a reserved bit, or an extended Oct bits in subheader of MAC PDU.

In some embodiments, the PHY layer signaling includes a scheduling request (SR) signaling. In some embodiments, information carried by the SR is determined by a PUCCH format, a predefined time and frequency transmission resource, a sequence, and/or code-point. In some embodiments, the second indication is valid within a first time duration, wherein the time duration is determined by a first timer. In some embodiments, the second indication is not transmitted within a second time duration, wherein the second time duration is determined by a second timer. In some embodiments, an ending time of the first time duration is configured by RRC signaling. In some embodiments, a start time of the first time duration is determined by a slot offset, and/or a symbol offset. In some embodiments, an ending time of the second time duration is configured by RRC signaling. In some embodiments, a start time of the second time duration is determined by a slot offset, and/or symbol offset. In some embodiments, the second indication includes the delta index information or the scaling factor information, wherein a transmission of the second indication is associated with a counter.

In some embodiments, the counter includes any one or more of the following characteristics: (1) the counter increases or decrements after the transmission of the second indication, and (2) the counter is reset in response to the transmitting the BSR. In some embodiments, the table includes a first table, a second table or a third table, wherein at least one of the first table or the second table is associated with a third table. In some embodiments, the table is the first table, wherein the table includes N total number of entries where N is an integer and is power of 2. In some embodiments, the maximum data amount of a M-th entry of a third table is that of an i-th entry of the first table, wherein 0<i<M, wherein M<N, and wherein M and i are integers. In some embodiments, the maximum data amounts of last N-M entries of a third table are that of entries of the first table, a ratio of data amount in two nearby entries, a former data amount dividing the later data amount, from a U-th entry to a (U+Q−1)-th entry of the first table is larger than S and less than R, S is less than 0.7 or 0.9, and R is less than 1, and where N−M<Q<N, i<U<N, and U is an integer. In some embodiments, the granularity from the U-th entry to the (U+Q−1)-th entry of the first table is finer than a W-th entry to a (W+T−1)-th entry of the third table, wherein W and T are integers, and 0<W<N−T, T<N.

In some embodiments, a data amount of any one of the last N−Q−i entries of the first table is K times of a maximum of a third table, respectively, wherein K is larger than 1. In some embodiments, the table is the second table, wherein the table includes P times of N total number of entries where P and N are integers and are the power of 2. In some embodiments, the maximum data amount of N entries of a third table is that of the entries of a second table. In some embodiments, a ratio of data amount in two nearby entries, a former data amount dividing the later data amount, from a U-th entry to a (U+Q−1)-th entry of the second table is larger than S and less than R, and S is less than 0.7 or 0.9, and R is less than 1, where 1<U<P*N, 1<Q<P*N, where Q and U are integers. In some embodiments, the granularity from U-th entry to (U+Q−1)-th entry of the second table is finer than the W-th entry to the (W+T−1)-th entry of the third table, wherein W and T are integers, and 0<W<N−T, T<N.

In some embodiments, a data amount of any one of the last (P−1)*N−Q entries of a second table is K times of the maximum of a third table, wherein K is larger than 1. In some embodiments, the data amount is indicated by the index including any one or more of the following: (1) a corresponding maximum data amount indicated by the index is the data amount, (2) a rounded result of corresponding maximum data amount indicated by the index multiplying a scaling factor determined by the second indication is the data amount, (3) the rounded result of corresponding minimum data amount indicated by the index multiplying a scaling factor determined by the second indication is the data amount, and (4) the rounded result of corresponding maximum data amount of the table multiplying a scaling factor determined by the second indication is the data amount, wherein the rounded result is a result of flooring, ceiling, or rounding. In some embodiments, the scaling factor is one of a plurality of values in candidate scaling factor determined by at least one of the following: RRC signaling, MAC CE signaling. In some embodiments, the data amount is determined by the rounded result of corresponding maximum data amount multiplying a scaling factor, the scaling factor is larger than 0.7 or 0.9, and less than 1.

In some embodiments, the data amount is determined by the rounded result of corresponding minimum data amount multiplying a scaling factor, the scaling factor is larger than 1, and less than 1.5 or 1.2. In some embodiments, the data amount is determined by the rounded result of corresponding maximum data amount of the table multiplying a scaling factor, the scaling factor is larger than 1.

Another example wireless communication method includes receiving, by a network device, a buffer status reporting (BSR), wherein the BSR includes an index that indicates an amount of data for transmission by the communication device, wherein the index corresponding to data amount is from a table, and wherein each index in the table is associated with one maximum data amount.

In some embodiments, the BSR or the table is determined by a first indication, wherein the first indication is transmitted from the network device. In some embodiments, the first indication is carried by a RRC signaling, a MAC CE signaling, or a PHY layer signaling. In some embodiments, the PHY layer signaling includes at least a downlink control information (DCI). In some embodiments, the BSR includes a first BSR, or a second BSR. In some embodiments, the first BSR and/or the second BSR is associated with the table. In some embodiments, the method further includes receiving, by a network device, a second indication, wherein the second indication includes any one or more of: a type of BSR, a table for BSR, a delta index information, or a scaling factor information. In some embodiments, the second indication is carried by a RRC signaling, a MAC CE signaling, a MAC CE header, or a PHY layer signaling.

In some embodiments, the RRC signaling includes any one or more of a UE capability, or UE assistance information. In some embodiments, the MAC CE signaling includes an information of a number of logical channels, or a BSR. In some embodiments, the MAC CE header includes any one or more of a LCID, an eLCID in a subheader of a MAC PDU, a reserved bit, or an extended Oct bits in subheader of MAC PDU. In some embodiments, the PHY layer signaling includes a SR signaling. In some embodiments, information carried by the SR is determined by a PUCCH format, a predefined time and frequency transmission resource, a sequence, and/or code-point.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1A shows a structure of buffer status reporting (BSR) signaling in current technology.

FIG. 1B shows a BSR mechanism in current technology.

FIG. 1C shows a flowchart for BSR signaling to gNB.

FIG. 1D shows a diagram that shows that a new data request is associated with BSR signaling.

FIG. 1E shows the base station preconfiguring BSR type and/or BS level table usage for a user equipment (UE).

FIG. 1F shows a flowchart for a UE determining a type of BSR signaling and table usage.

FIG. 1G shows a flowchart where the UE transmits configuration information and scaling factor to base station.

FIGS. 2A and 2B show two example tables that show an index value associated with each of a plurality of BS levels.

FIGS. 3A to 3D show example size and structures of a first BSR and/or second BSR.

FIG. 4A shows a MAC PDU subheader that includes an identifier that indicates a selected BS level table.

FIG. 4B shows a MAC subheader that includes an identifier that indicates a selected BS level table.

FIGS. 5A and 5B show example implementations for scheduling resource (SR) signaling.

FIGS. 6 and 7 show entries of a third table that are obtained or derived from the first table.

FIG. 8 shows a graph that indicates that some indices can be merged in third BS level table without large capacity loss, in a pose/control traffic model.

FIG. 9 shows a graph that indicates that some entries insert in some of two nearby entries of a third BS level table can improve the capacity performance in video traffic model.

FIGS. 10 and 11 show entries of a third table that are obtained or derived from the second table.

FIG. 12 shows an exemplary block diagram of a hardware platform that may be a part of a network device or a communication device.

FIG. 13 shows an example of wireless communication including a base station and user equipment (UE) based on some implementations of the disclosed technology.

FIG. 14 shows an exemplary flowchart for transmitting a BSR.

FIG. 15 shows an exemplary flowchart for receiving a BSR.

### DETAILED DESCRIPTION

When variable data amount service, which includes e.g., virtual reality and augmented reality, is transmitted in a wireless system, user equipment (UE) can utilize a precise BSR to indicate the data volume or an amount of data to be transmitted to a base station so that the base station is capable of allocating precise radio resource for physical uplink shared channel (PUSCH). A precise BSR can reduce the utilization of radio resource as well as increasing the system capacity. Thus, this patent document describes techniques that can resolve a technical problem related to waste of allocation of PUSCH resources. The techniques described in this patent application can also be applicable to data amount services that may not be variable.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Current BSR Technology and Proposed Improvements

### I.(a). BSR Signaling Structure

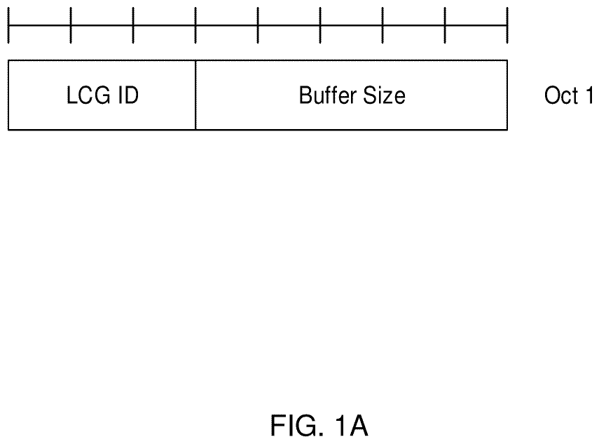

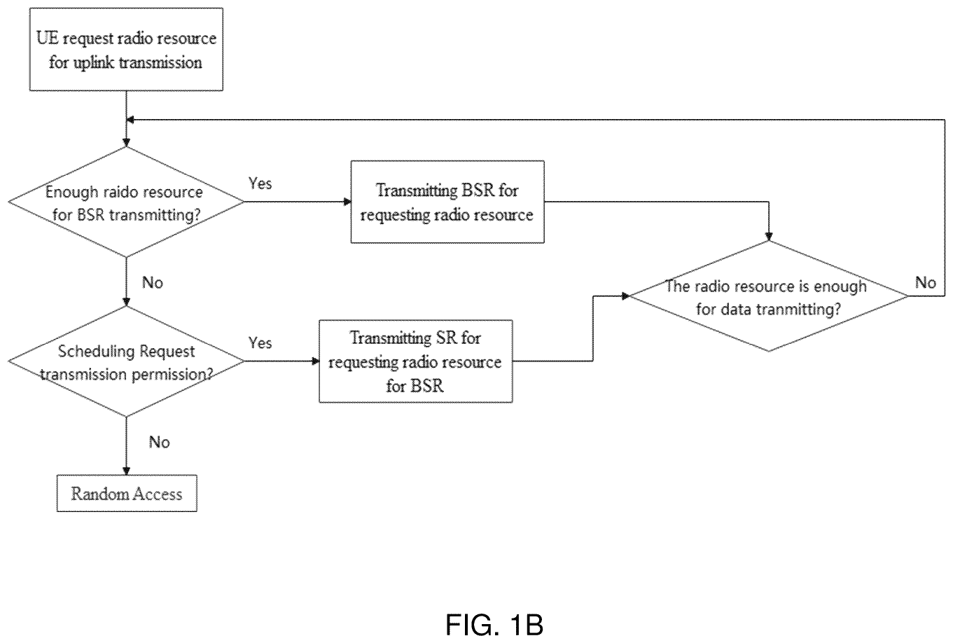

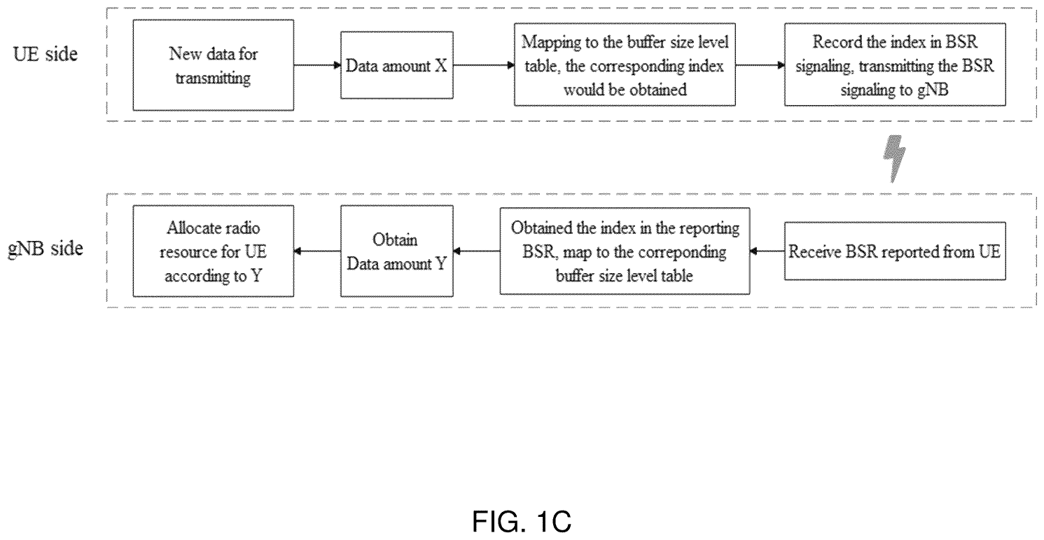

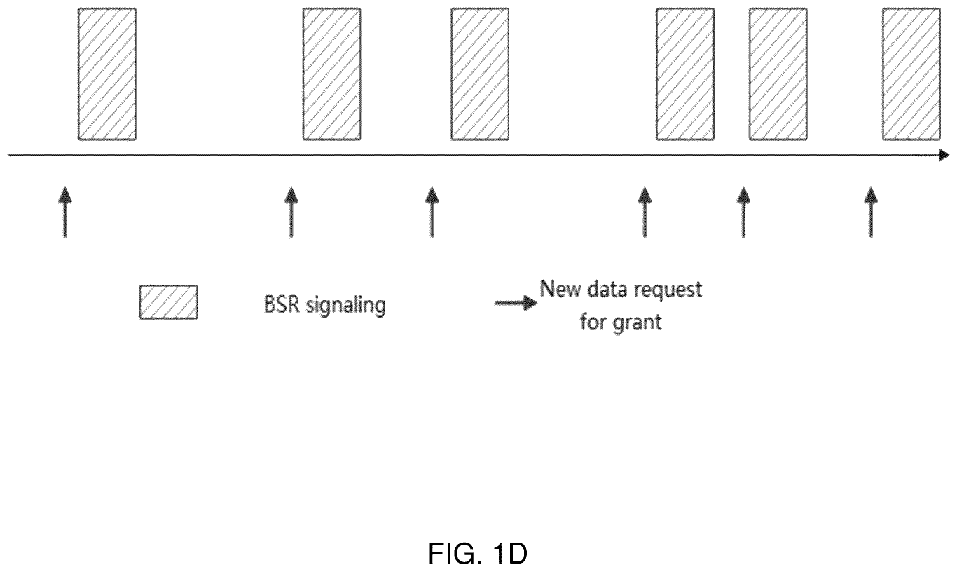

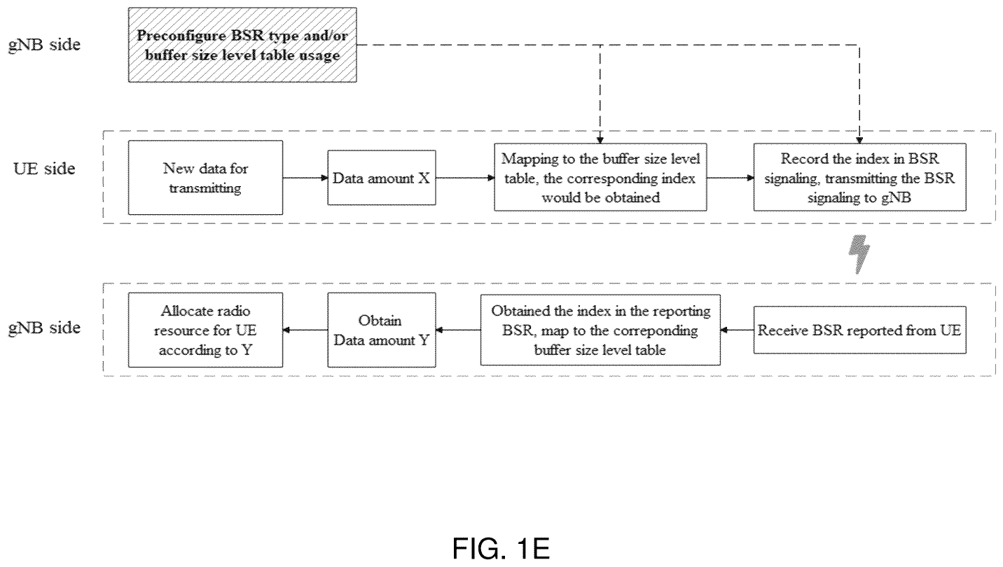

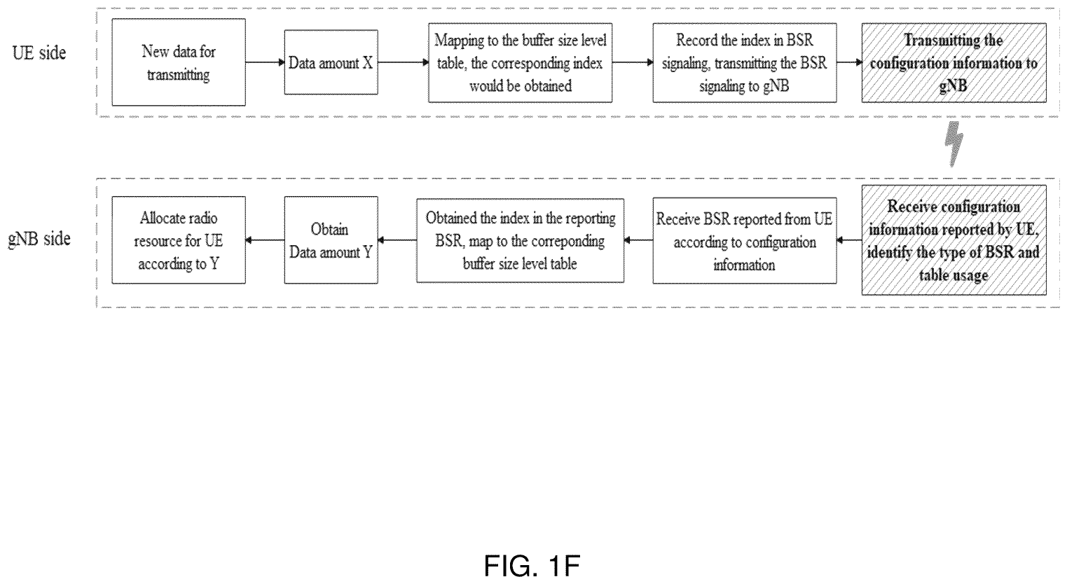

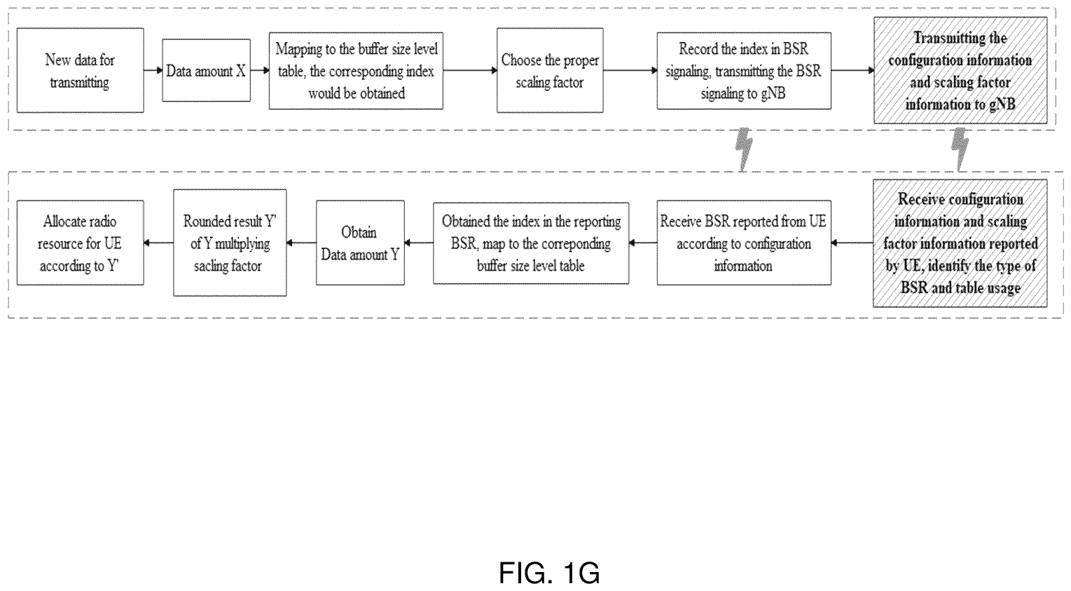

In current technology, BSR is transmitted via a MAC CE signaling. And the structure of the signaling is show in FIG. 1A, for example, as a 5-bit BSR table. In FIG. 1A, the field “Buffer Size” carries the one of the indexes of the table, while the field “LCG ID” carries the logical channel group (LCG) identifier indication, including e.g. ranging from 0 to 7.

### I.(b). The Legacy Mechanism of BSR Signaling Reporting

In general, for uplink transmission, UE ought to report its data amount to gNB for requesting radio resource for this data (i.e, requesting radio resource for PUSCH). And the information for data amount is carried by BSR signaling. In current specification, the BSR mechanism is shown in FIG. 1B

In this patent document, techniques are described for the mechanism for BSR triggering or a SR triggering for requesting radio resource. Thus, this patent document does not further describe the random access box in FIG. 1B. In this patent document focuses, among other things, on the “Transmitting BSR for requesting radio resource” box.

In general, and as shown in FIG. 1C, UE is capable of knowing how much the actual data amount X is. As a result, UE uses the actual data amount to obtain an index according to BS level table. And the index UE obtained is carried by BSR signaling, which would be reported to gNB. From gNB perspective, it receives the BSR from the UE, and the index UE reporting is obtained. Then, gNB is capable of knowing the data amount Y indicated by the reported index according to the BS level table. Finally, gNB allocate radio resource for UE according to data amount Y. There is a gap (or difference) between Y and X. If the gap becomes larger, the radio resource gNB allocates would waste more, which can reduce system capacity.

In general, and as shown in FIG. 1D, when a new data is requested for radio resource, BSR signaling is transmitted to inform the uplink data amount to gNB.

### I.(c). The Improved Proposed Mechanisms of BSR Signaling Reporting

Based on the problem of current BSR mechanism mentioned above, the improvement as further described in this patent document focuses on, among other things, designing precise BS level table to reduce the gap between X and Y. Also, some signaling for indication or BSR enhancement are innovated to achieve flexible selection of BS level table with different granularity according to the traffic characteristic.

For the precise BS level table design, in a word, granularity of some entries of legacy table should be much finer, while granularity of some entries of legacy table should be remained or coarser. The maximum of the legacy table should be extended to support much larger data amount.

For the new signaling for indication or BSR enhancement for flexible selection, the proposed mechanisms can be divided into two directions as shown in FIG. 1E and FIG. 1F, respectively. The first one is gNB determines UEs which BSR signaling is used and/or which table the index in BSR indicates. In this case, gNB transmit the configuration information to UEs to determine type of BSR signaling and/or table use for BSR indication. The second one is UE determines the type of BSR signaling and/or table use for BSR indication by its own. In this case, gNB is not aware of which type of BSR signaling and table usage a UE uses. As a result, the UE should not only transmit BSR to gNB, but also transmit an indication information (including type of BSR and/or used for BSR indication) to help gNB decode the data amount of UE correctly.

### II. Introduction to BSR Techniques

In this patent document, indication of the BS level of an uplink shared channel (e.g., PUSCH) can be indicated in or can be included in BSR. In this patent document, the BSR can include an index of a first table, an index of a second table and/or an index of a third table

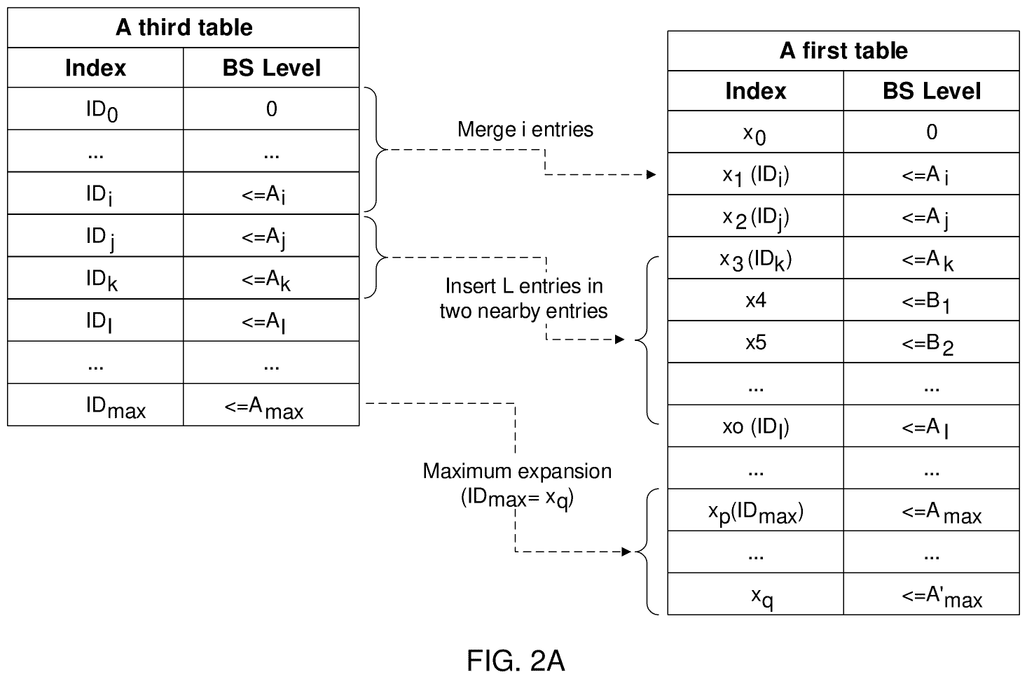

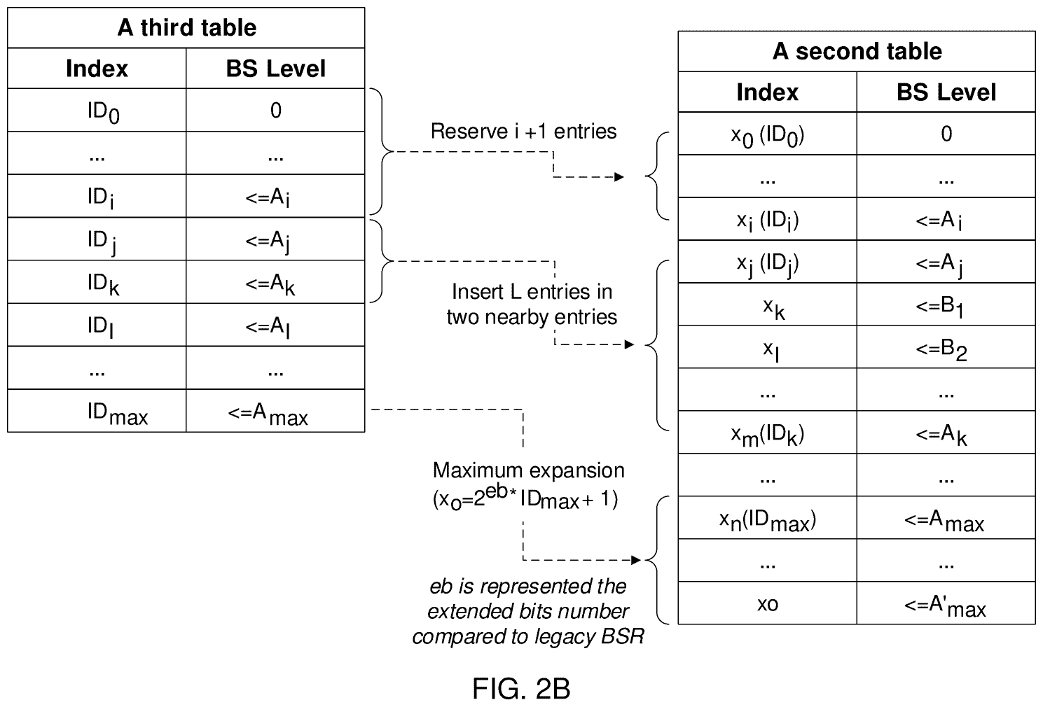

FIG. 2A shows a first table that includes at least some entries that are same with the indices of a third table and some additional indices between the nearby indices (e.g., between two adjacent indices) of a third table, without increasing the total number of indices of a third table. In FIG. 2A, the variables A and B with subscripts in the BS Level column indicate maximum amounts of data (e.g., in bytes), where each BS level can be associated with a different maximum amount of data. In some embodiments, as illustrated in FIG. 2A, a set of merged entries of the first table are obtained from a first number of entries (shown as “i entries” in FIG. 2A) in the third table, where each merged entry includes one or more entries from the first number of entries. In some embodiments, as illustrated in FIG. 2A, a set of inserted entries of the first table located after the first number of entries in the third table.

FIG. 2B shows a second table in which additional entries are inserted in between the nearby entries of a third table, thereby increasing (e.g., doubling) the total number of indices of a third table. In FIG. 2B, the variables A and B with subscripts in the BS Level column indicate maximum amounts of data (e.g., in bytes), where each BS level can be associated with a different maximum amount of data.

Two additional tables (any of which are referred to as “third table”) are shown below for legacy BS level tables as described in TS 38.321 V16.4.0. The “BS level” shown in FIGS. 2A and 2B for the third table is the same as “BS value” shown in Tables 6.1.3.1-1 and 6.1.3.1-2:

TABLE 6.1.3.1-1
Buffer size levels (in bytes) for 5-bit Buffer Size field

| | BS |
|---|---|
| Index | value |
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

TABLE 6.1.3.1-2
Buffer size levels (in bytes) for 8-bit Buffer Size field

| | BS |
|---|---|
| Index | value |
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

In this patent document, index to BS level mapping can describe a mapping between a plurality of indexes and a plurality of BS levels, such that one index maps to one BS level. For a certain index, the BS level can be reported as a maximum of corresponding BS level range. In this patent document precise UL data resource can describe enhanced BS level indication. And, in this patent document, enhanced BS level indication can include a first BSR or a second BSR.
a) The term “first BSR” refers to the legacy BSR in TS38.321
   A first BSR can indicates a first table or a third table
b) The term “second BSR” can include the exemplary BSR technique described in this patent document.
   Second BSR can have the same length of a first BSR
      A second BSR is capable of indicating a first table
   Second BSR can have n more bits compared to a first BSR
      A second BSR is capable of indicating a second table

The term “first indication” refers to the configuration information transmitted by gNB to UE, while the term “second indication” refers to the configuration information transmitted by UE to gNB.

In this patent document, the technical problems that need to be addressed include at least the following:
(1) The interpretation of the BSR
(2) The first indication
(3) The second indication
(4) The design for precise buffer size level table
(5) The determination of data volume of an uplink shared channel (e.g., PUSCH)

Sections III to VII below describe example technical solutions to at least the four technical problems mentioned above.

### III. The Interpretation of the BSR

The BSR signaling includes a first SR, or a second BSR.

### (a). A First BSR (Type-1 Interpretation)

A first BSR is a legacy BSR. The structures of the first BSR are shown as following:

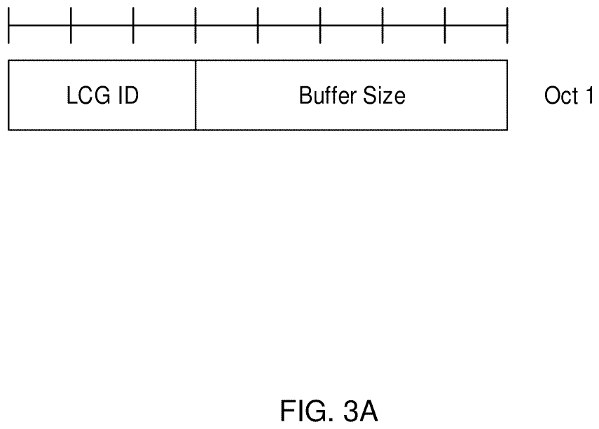

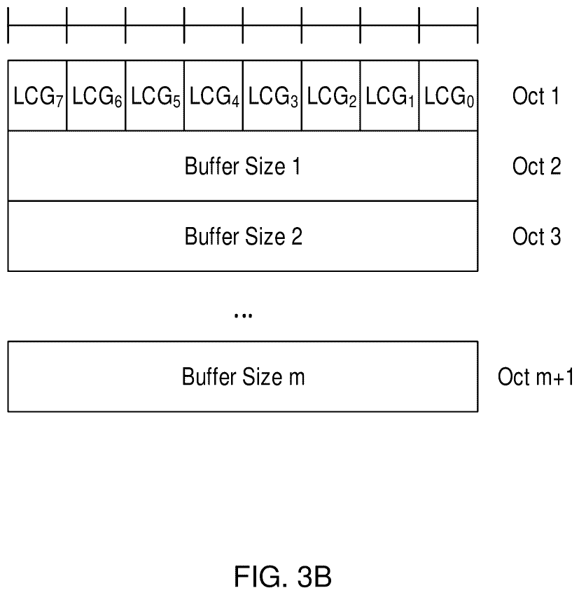

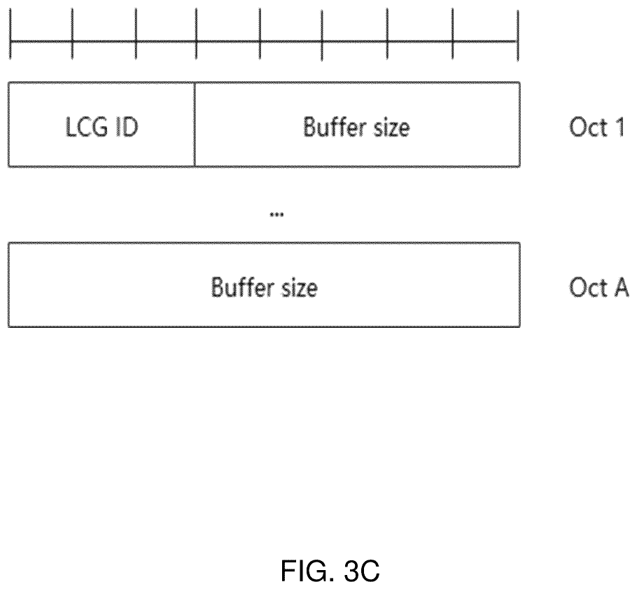

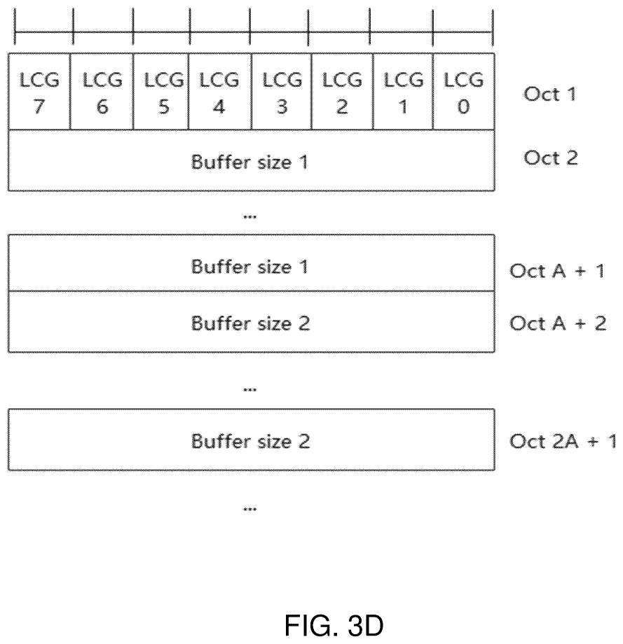

If only one logical channel has pending data, the structures is depicted in FIG. 3A

The field “LCG ID” indicates which logical channel group identifier the data belong to, and it is ranging from 0 to 7, while the field “Buffer Size” carries one of the indexes of the table. The table can be a first table, which is a new design table with finer granularity based on a third table, or a third table, which is a legacy table in current technical specification TS 38.321.

In some embodiments, the first BSR corresponds to one table.

In some embodiments, the first BSR corresponds to multiple tables.

If more than one logical channel have pending data, the structure is depicted in FIG. 3B.

The field “LCGi” indicates which logical channel groups have pending data, while the field “Buffer Size” carries one of the indexes of the table. The table can be the first table, which is a new design table with finer granularity based on the third table, or the third table, which is the legacy table in current Spec. (TS 38.321).

In some embodiments, the first BSR corresponds to one table.

In some embodiments, the first BSR corresponds to multiple tables.

### (b). A Second BSR (Type-2 Interpretation)

A second BSR signaling is a new designed BSR.
(1) In some embodiments, the size and structure of the second BSR is the same as the first BSR.
   In some cases, if only one logical channel has pending data, the structures is depicted in FIG. 3A.
   In some cases, if more than one logical channels have pending data, the structures is depicted in FIG. 3B.
(2) In some embodiments, a size of the second BSR is larger than that of the first BSR.
   In some cases, if only one logical channel has pending data, the size of the second BSR is A times of 8, wherein A is larger than 1. The structure of the second BSR is depicted in FIG. 3C.

The first three bits indicates the LCG ID. And the rest 8A-3 bits carries a index corresponding to a second table with 2^{8A-3} total number of entries.

In some embodiments, the second BSR corresponds to one table.

In some embodiments, the second BSR corresponds to multiple tables.
In some cases, if more than one logical channel has pending data, the structures is depicted in FIG. 3D.

The first Oct bits indicates the which LCGs have pending data, and next A Oct bits (from October 2 to Oct A+1) carries a index corresponding to a second table with 24 total number of entries for the first LCG who has pending data. While the next A bits (from Oct A+2 to October 2A+1) carries a index corresponding to a second table with 24 total number of entries for the second LCG who has pending data.

In some embodiments, the mapping order for field “LCGi” and “Buffer size m” is from most significant bit (MSB) to least significant bit (LSB).

For example, if the first Oct bits of the second BSR is “10000100”, the “Buffer size 1” indicates the index corresponding to a second table for LCG7, while the “Buffer size 2” indicates the index corresponding to a second table for LCG2.

In some embodiments, the mapping order for field “LCGi” and “Buffer size m” is from LSB to MSB.

For example, if the first Oct bits of the second BSR is “10000100”, the “Buffer size 1” indicates the index corresponding to a second table for LCG2, while the “Buffer size 2” indicates the index corresponding to a second table for LCG7.

In some embodiments, the second BSR corresponds to one table.

In some embodiments, the second BSR corresponds to multiple tables.

### IV. The First Indication

In some embodiments, the first indication is transmitted from the network device to communication device, and determines a type of BSR (Type-1 interpretation, Type-2 interpretation) and a table to be used by the communication device for BSR.

In some embodiments, The first indication determines the type of BSR. The first indication is determined by at least one of the following

### a) Radio Resource Control (RRC) Signaling

In some embodiments, the RRC signaling for BSR type determination is on BSR-config.

| BSR-Config ::= | SEQUENCE { |
|---|---|
| .... | |
| BSRtype | ENUMERATED {bsr1,bsr2,... } |

}

For example, if the BSRtype in BSR-config is bsr1 in the base station, UEs are informed to use one of the first BSR. If the BSRtype in BSR-config is bsr2 in the base station, UEs are informed to use one of the second BSR.

### b) Mac Ce

A downlink MAC CE signaling is designed for determination of the type of BSR. Correspondingly, a reserved LCID field or a reserved enhanced LCID (eLCID) field should be utilized to indicate the MAC CE signaling.

TABLE 6.2.1-1
Values of LCID for DL-SCH

| Codepoint/Index | LCID values |
|---|---|
| 0 | CCCH |
| 1-32 | Identity of the logical channel |
| 33 | Extended logical channel ID field |
| | (two-octet eLCID field) |
| 34 | Extended logical channel ID field |
| | (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for |
| | UE-specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 6.2.1-1b
Values of one-octet eLCID for DL-SCH

| Codepoint | Index | LCID values |
|---|---|---|
| 0 to 244 | 64 to 308 | Reserved |
| 245 | 309 | Serving Cell Set based SRS Spatial |
| | | Relation Indication |
| 246 | 310 | PUSCH Pathloss Reference RS Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States |
| | | Activation/Deactivation for UE- |
| | | specific PDSCH |
| 251 | 315 | Duplication RLC |
| | | Activation/Deactivation |
| 252 | 316 | Absolute Timing Advance Command |
| 253 | 317 | SP Positioning SRS |
| | | Activation/Deactivation |
| 254 | 318 | Provided Guard Symbols |
| 255 | 319 | Timing Delta |

If the downlink MAC CE is used, in some embodiments, codepoint/index 35-46 of LCID value in subheader in MAC PDU can be utilized to identify the MAC CE signaling. In some embodiments, codepoint/index 0-244, and 64-308 of eLCID value in subheader in MAC PDU can be utilized to identify the MAC CE signaling.

### c) Physical Layer Signaling

The downlink physical layer signaling includes a downlink control information (DCI). In some embodiments, the DCI is DCI format 0_0, DCI format 0_1, DCI format 0_2 or an additional DCI format 2. For the DCI format 0/2 for carrying the type of BSR information, additional RNTI is considered.

### d) Combination of RRC Signaling and Physical Layer Signaling

In some embodiments, RRC signaling configures the BSRtype for a type of BSR, then the DCI indicates to UE which type of BSR is to use.

In some embodiments, the first indication determines a table to be used by the communication device for BSR. The first indication is determined by any one or more of the following:

### (a) RRC Signaling

If the BSR signaling is the first BSR, and the number of a first table is 1. The first indication can be the bsrTableSelectionFlag in RRC signaling BSR-config.

| BSR-Config ::= | SEQUENCE { |
|---|---|
| ... | |
| bsrTableSelectionFlag | BOOL{TRUE, FALSE} |

}

In some embodiments, if bsrTableSelectionFlag is TRUE, then the first BSR corresponds to the first table, while if bsrTableSelectionFlag is FALSE, then the first BSR corresponds to the third table.

In some embodiments, if bsrTableSelectionFlag is FALSE, then the first BSR corresponds to the first table, while if bsrTableSelectionFlag is TRUE, then the first BSR corresponds to the third table.

If the BSR signaling is the first BSR or the second BSR, and the number of a first table or a second table is larger than 1. The first indication can be the bsrTable in RRC signaling BSR-config. In some embodiments, the bsrTable includes all the table, including, e.g. the first table, the second table and the third table.

| | |
|---|---|
| BSR-Config ::= | SEQUENCE { |

...

| | |
|---|---|
| bsrTable | ENUMERATED{Table1, Table2, Table3,...,Table N} |

}

For example, Table 1 and Table 2 is the third table. Table 3, Table 4, . . . . Table i are the first tables, while Table (i+1), . . . , Table N are the second tables.

In some embodiments, the different tables correspond to different first indications.

| | |
|---|---|
| BSR-Config ::= | SEQUENCE { |

...

| | |
|---|---|
| bsrTable1 | ENUMERATED{Table1, Table2, Table3,...,Table N} |
| bsrTable2 | ENUMERATED{Table1, Table2, Table3,...,Table N} |
| bsrTable3 | ENUMERATED{Table1, Table2, Table3,...,Table N} |

}

For example, bsrTable1 is to determine a third table, bsrTable2 is to determine a first table, while bsrTable3 is to determine a second table.

In some embodiments, the first table and the second table correspond to different first indications, while the third table is determined implicitly according to the first indication.

### (b) MAC CE Signaling

A new downlink MAC CE signaling is designed for a table to be used by the communication device for BSR. Correspondingly, a reserved LCID field or a reserved enhanced LCID (eLCID) should be utilized to indicate the new MAC CE signaling

TABLE 6.2.1-1
Values of LCID for DL-SCH

| Codepoint/Index | LCID values |
|---|---|
| 0 | CCCH |
| 1-32 | Identity of the logical channel |
| 33 | Extended logical channel ID field (two-octet eLCID |
| | field) |
| 34 | Extended logical channel ID field (one-octet eLCID |
| | field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 6.2.1-1b
Values of one-octet eLCID for DL-SCH

| Codepoint | Index | LCID values |
|---|---|---|
| 0 to 244 | 64 to 308 | Reserved |
| 245 | 309 | Serving Cell Set based SRS Spatial |
| | | Relation Indication |
| 246 | 310 | PUSCH Pathloss Reference RS Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States |
| | | Activation/Deactivation for UE- |
| | | specific PDSCH |
| 251 | 315 | Duplication RLC |
| | | Activation/Deactivation |
| 252 | 316 | Absolute Timing Advance Command |
| 253 | 317 | SP Positioning SRS |
| | | Activation/Deactivation |
| 254 | 318 | Provided Guard Symbols |
| 255 | 319 | Timing Delta |

If the new downlink MAC CE is designed, in some embodiments, codepoint/index 35-46 of LCID value in subheader in MAC PDU can be utilized to identify the MAC CE signaling. In some embodiments, codepoint/index 0-244, and 64-308 of eLCID value in subheader in MAC PDU can be utilized to identify the MAC CE signaling.

### (c) Physical Layer Signaling

The downlink physical layer signaling includes a downlink control information (DCI). In some embodiments, the DCI is DCI format 0_0, DCI format 0_1, or DCI format 0_2. where DCI is DCI format 0_0, DCI format 0_1, DCI format 0_2 or the new DCI format 2. For the DCI format 0/2 for carrying the type of BSR information, new RNTI is considered.

### (d) Combination of RRC Signaling and Physical Layer Signaling

In some embodiments, RRC signaling configures the bsr Table for a table usage, then the DCI indicates explicitly to UE which table is to use.

### V. The Second Indication

The second indication is transmitted by the communication device to the network device and determines the type of BSR, the table for BSR, the delta index information or, the scaling factor, for example as shown in FIG. 1G. In some embodiments, the second indication is transmitted by the communication device to the network device and determines the BSR, and/or the scaling factor.

The second indication is transmitted in at least one of the following:

### (a) Radio Resource Control (RRC) Signaling

In some embodiments, a RRC signaling includes a UE capability, or a UE assistance information. And determination for second indication in the UE capability, or the UE assistance information is valid at a first time duration.

The first time duration of UE capability or a UE assistance information can be determined by RRC signaling. In some embodiments, a start time of the first time duration is configured, indicated, or determined by RRC signaling. For example, RRC signaling configures, indicates, or determines the slot offset or a symbol offset for the start time.

### (b) MAC CE Signaling

In some embodiments, a MAC CE signaling includes an information of the number of logical channels having pending data. There is an Oct bits indicating which LCGs has pending data. As a result, the number of logical channels having pending data can be interred. If the number of logical channels having pending data is 1, short BSR and corresponding 5-bit table are considered. While if the number of logical channels having pending data is larger than 1, long BSR and corresponding 8-bit table are considered.

### (c) MAC CE Header

In some embodiments, the type of the BSR is determined by the second indication. LCID field or eLCID field in a MAC PDU subheader is capable of being utilized for identifying different BSR type.

And determination for second indication in the MAC CE header is valid at a first time duration.

The first time duration of MAC CE header can be determined by RRC signaling. In some embodiments, a start time of the first time duration is configured, indicated, determined by RRC signaling. For example, RRC signaling configures, indicates, or determines the slot offset or a symbol offset for the start time.

TABLE 6.2.1-2
Values of LCID for UL-SCH

| Codepoint/Index | LCID values |
|---|---|
| 0 | CCCH of size 64 bits (referred to as “CCCH1” in TS |
| | 38.331 [5]) |
| 1-32 | Identity of the logical channel |
| 33 | Extended logical channel ID field (two-octet eLCID |
| | field) |
| 34 | Extended logical channel ID field (one-octet eLCID |
| | field) |
| 35-44 | Reserved |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS |
| | 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

The LCID value of the second BSR can be in the reserved LCID value 35-44, 47.

TABLE 6.2.1-2b
Values of one-octet eLCID for UL-SCH

| Codepoint | Index | LCID values |
|---|---|---|
| 0 to 249 | 64 to 313 | Reserved |
| 250 | 314 | BFR (four octets Cᵢ) |
| 251 | 315 | Truncated BFR (four octets Cᵢ) |
| 252 | 316 | Multiple Entry Configured Grant |
| | | Confirmation |
| 253 | 317 | Sidelink Configured Grant |
| | | Confirmation |
| 254 | 318 | Desired Guard Symbols |
| 255 | 319 | Pre-emptive BSR |

The eLCID value of the second BSR can be in the reserved LCID value, whose Codepoint is from 0 to 249 and Index is from 64 to 313.

In some embodiments, the table for BSR is determined by the second indication.

The second indication transmits in MAC CE subheader.

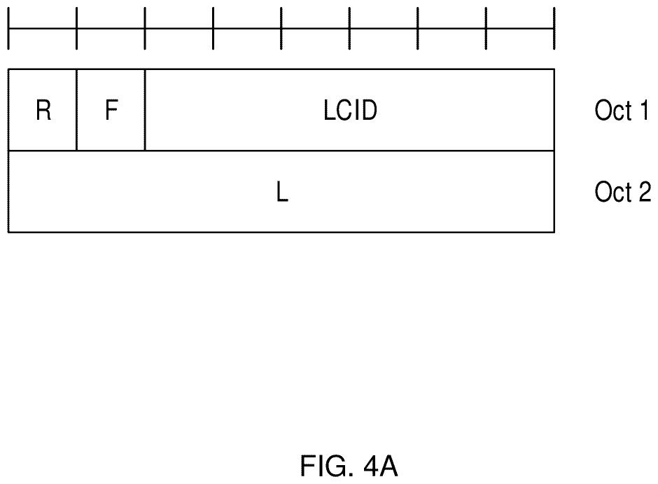

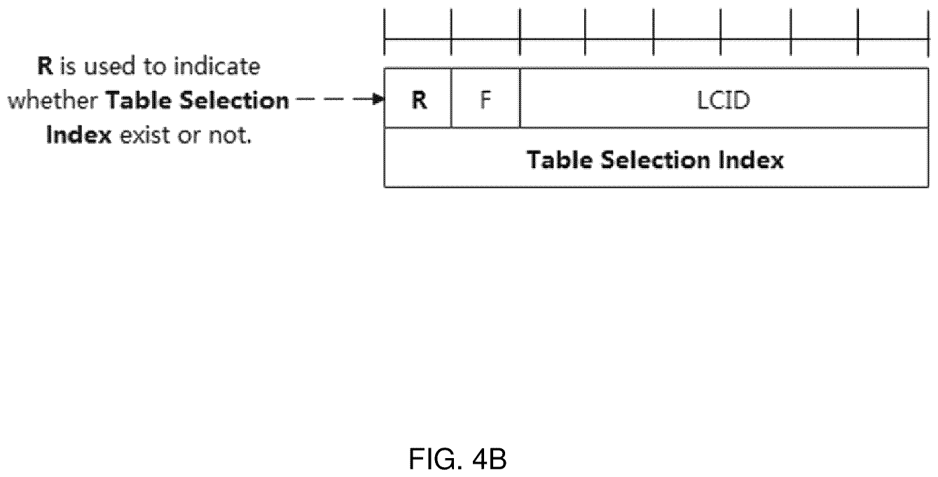

In some embodiments, if the number of the first table is 1, the second indication can be the reserved bit of the MAC CE (e.g. BSR signaling) subheader as shown in FIG. 4A.

For example, if the LCID value represents the MAC PDU is the first BSR MAC CE signaling, the reserved bit “R” is capable of indicating the table switching.

For example, if “R” is 1, the first BSR corresponds to a first table, while if “R” is 0, the first BSR corresponds to a third table.

For example, if “R” is 1, the first BSR corresponds to a third table, while if “R” is 0, the first BSR corresponds to a first table.

In some embodiments, if the number of the first table or the second table is larger than 1, the second indication can be the reserved bit as well as an extended Oct bits of the BSR signaling subheader as shown in FIG. 4B.

For example, if “R” is 1, the second Oct bits represents the “Table Selection Index” to indicate the index of the table used.

If “R” is 0, the second Oct bits would not exist and the MAC CE subheader falls back to that in current Spec.

### (d) Physical Layer Signaling

The second indication is transmitted in physical layer signaling. In some embodiments, the SR signal is indicated before a set of uplink data request periods, BSR type and table switching information are carried in the SR signaling, or other UL signaling, such as BSR.

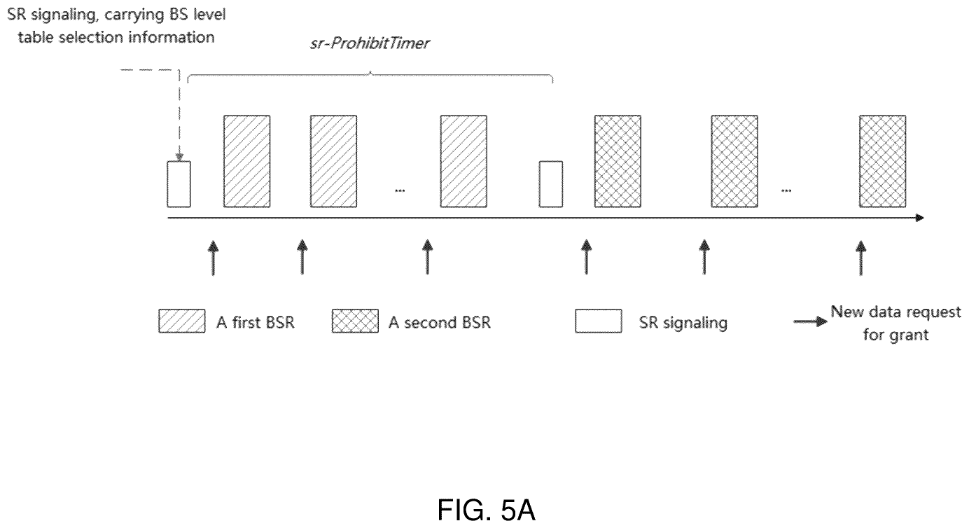

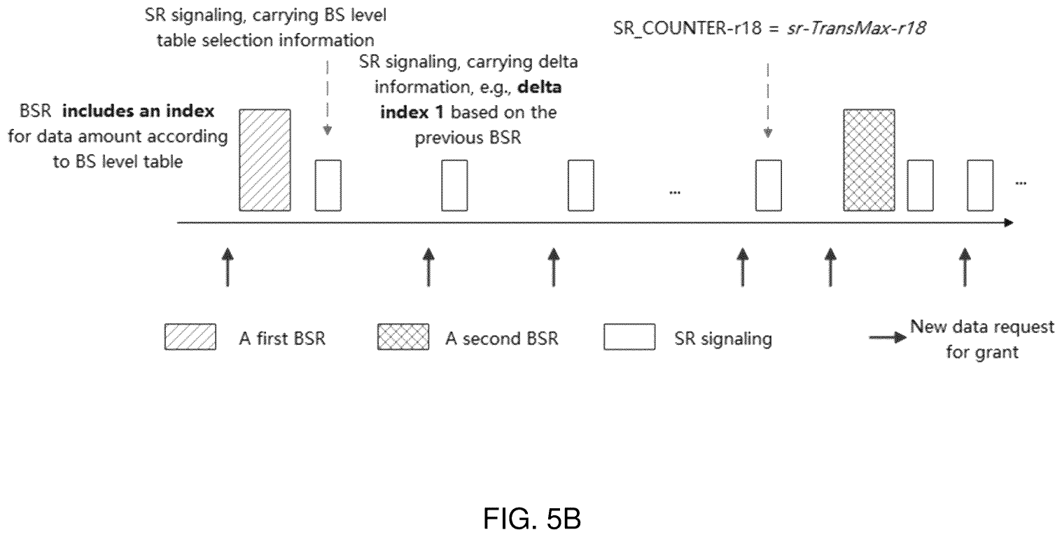

When a new data is requested for radio resource, the SR is triggered firstly, where SR carries the table switching information. Subsequently, SR signaling would trigger the BSR signaling, which is depicted in FIG. 5A. In a second time duration, the same type of BSR corresponds to the same table both determined by the information SR carries. If out of the second time duration, the determination of type of BSR and table switching information expires. When a new data is requested for radio resource after the second time duration, another SR signaling is triggered for determining type and the table for following BSRs in its second time duration.

The second time duration of SR signaling can be determined by sr-ProhibitTimer-r18 in RRC signaling SchedulingRequestToAddMod. In some embodiments, a start time of the second time duration is configured, indicated, determined by RRC signaling. For example, RRC signaling configures, indicates, or determines the slot offset or a symbol offset for the start time. For the slot granularity of the offset, the start time can be the slot SR triggering, or the next k slots of SR triggering. For the symbol granularity of the offset, the start time can be the symbol SR triggering, or the next k symbols of SR triggering.

In some embodiments, the SR signaling can replace BSR signaling for data requesting based on after a BSR signaling is triggered, which is depicted in FIG. 5B.

When the first new data is requesting, BSR accompanied with a SR signaling, carrying configuration information, including e.g., the type of BSR, the table for BSR, delta index, or scaling factor information is reported to gNB for radio resource. Then, in the following new data request, the SR signaling is based on a counter, UE can use SR signaling to request radio resource instead of BSR signaling. The SR signaling is associated with the first triggering BSR based on the counter.

For example, if a BSR is transmitted for requesting radio resource for new UL data. The SR signaling would transmitted simultaneously with BSR, where SR carries the type of BSR, the table for BSR, the delta index information and/or the scaling factor. When SR is triggered, the counter would start to count the SR transmission times.

In some cases, when SR transmits, the counter increases by 1. If the counter reaches the maximum transmission times or another BSR is triggered, the counter would be reset. The maximum transmission times (e.g., sr-TransMax-r18) is configured by RRC signaling SchedulingRequestToAddMod.

The mechanism of maximum transmission times limitation is depicted as follows.

```
If SR_COUNTER_r18 < sr-TransMax-r18
  Increment SR_COUNTER_r18 by 1;
Else
  Trigger BSR for new UL data grant
```

In some cases, when SR transmits, the counter decrements by 1. If the counter reaches zero or another BSR is triggered, the counter would be reset. The minimum transmission times (e.g., sr-TransMin-r18) is configured by RRC signaling SchedulingRequestToAddMod.

The mechanism of minimum transmission times limitation is depicted as follows.

```
If SR_COUNTER_r18 > sr-TransMin-r18
  Decrements SR_COUNTER_r18 by 1;
Else
  Trigger BSR for new UL data grant
```

### VI. The Design for Precise Buffer Size Level Table

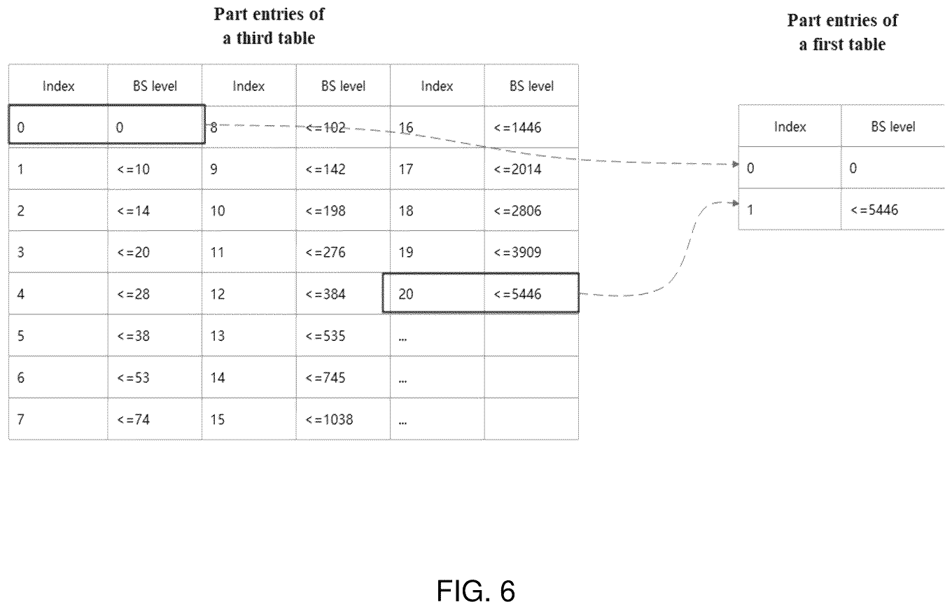

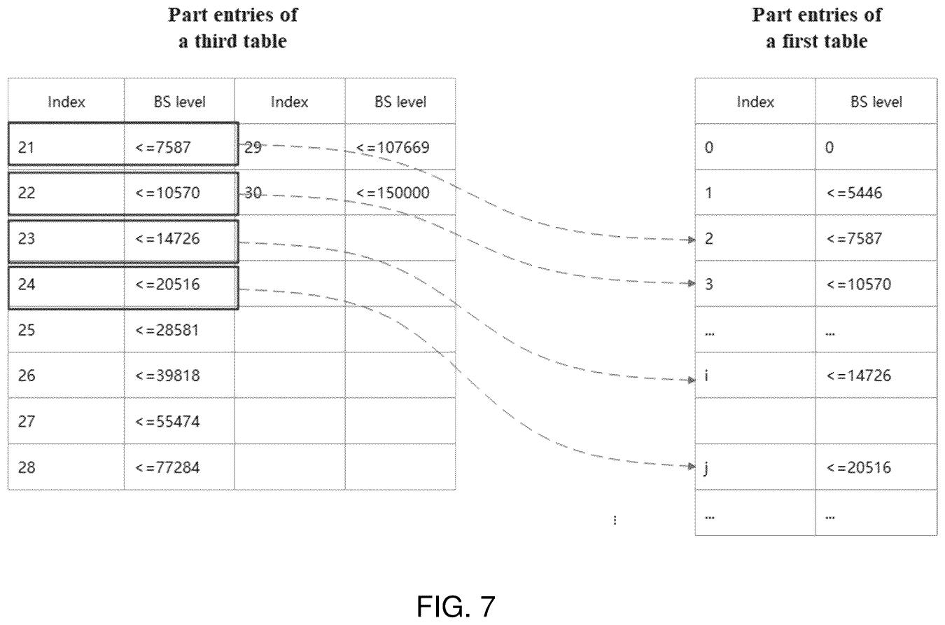

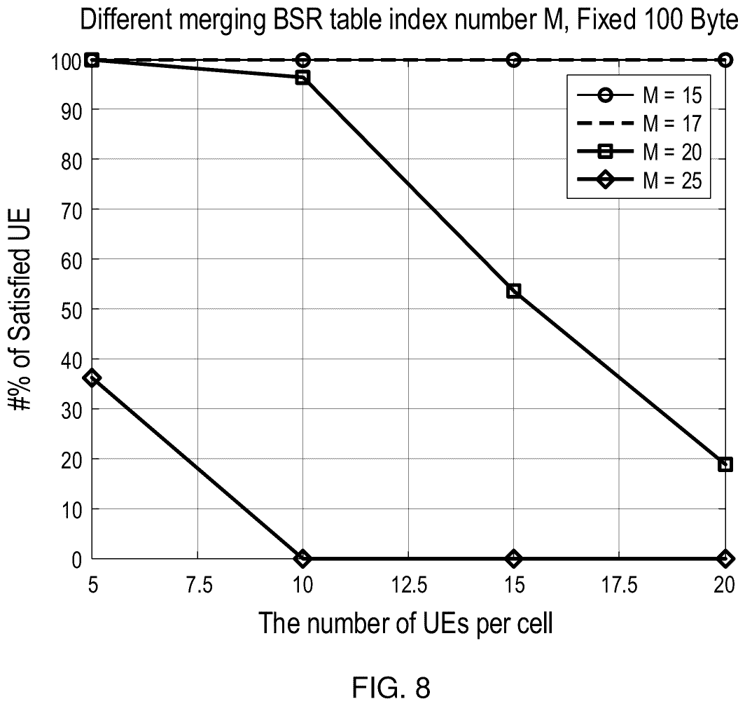

The first table is based on the third table with N total entries including the following features:
a) The first table has N entries, which is same with the third table, wherein N is a integer and, in some example, N can be a power of 2. For example, there are N=32 entries in the first 5-bit table, while there are N=256 entries in the first 8-bit table.
b) The maximum data amount of a M-th entry of a third table is the maximum data amount of an i-th entry of a first table, wherein M<N, i<M, wherein M and i are integers. For example, when M=21 and i=2, it implies that M entries of the third table have been compressed, merged, or reduced to i entries of the first table in order to saving the number of entries for achieve finer granularity in later entries of the third table as shown in FIG. 6.
   FIG. 8 implies that some indices can be merged in third BS level table without large capacity loss, in Pose/Control (Fixed 100 Byte) traffic model.
   For this merge, there would obviously cause radio resource waste for some small packet traffic, e.g., control signaling traffic, the packet size is around 100 Byte. We hope that for the first table design, the BS level for small packet traffic can be coarse relatively to save some entries for enhancing the indication granularity of the middle and later entries of the third table for large-packet traffic. But the performance for small packet traffic should not be reduced rapidly. As a result, FIG. 8 is to simulate the relationship between system capacity and the merging number of a third table.
   It seems that (90% satisfied UE is regard as the system capacity) for M=15, or M=17, the capacity is larger than 20 UE per cell, while the capacity is 10˜12 per cell for M=20, while the capacity is 0 UE per cell for M=24. FIG. 8 illustrates that there might be a proper M for merging without performance loss for small packet traffic.
      1) In some cases, M is determined by the maximum bearable BS level, which is relevant to:
         I. Modulation order
         II. Frequency domain resource
         III. Time domain resource
c) The maximum data amounts of last N-M entries of a third table are the maximum data amounts of the entries of a first table, where their indices in a first table are b₁, b₂, . . . , b_{N-M}. Based on the example mentioned above, the remaining entries of the third table are the entries of the first table. The procedure is depicted in FIG. 7
d) From the U-th entry to the (U+Q−1) entry of a first table include the following features:
   1) b₁, b₂, . . . , D_{N-M} is within Q entries
   2) L_{1,2} entries are within the entries pair between b₁ and b₂, L_{2,3} entries within the entries pair between b₂ and b₃, and so on, L_{N-M-1,N-M} entries within the entries pair between b_{N-M-1} and b_{N-M}
      I. The sum of L_{1,2}, L_{2,3} . . . and L_{N-M-1,N-M} is Q1, and Q1 is less than Q
         \textcircled{1} L_{i,j} is relevant to at least one of the following:
         Maximum bearable BS level
         The BS level range determined by bᵢ and bⱼ
         \textcircled{2} The ratio between data amounts determined by two nearby entries in Q entries is large than R and less than S.
         In some cases, R is larger than 0.7 or R is larger than 0.9.
         In this case, S is larger than R.

Based on the example mentioned above, the finer granularity enhancement is from index 21 to index 30 of the third table. For example, three entries have been inserted/added in the index 27 and index 28 of a third table, which all the entries are in the first table.

| Index (first | BS |
|---|---|
| table index) | level |
| X(index 27 in a | ≤55474 |
| third table) | |
| X + 1 | ≤A1 |
| X + 2 | ≤A2 |
| X + 3 | ≤A3 |
| (X + 4)(index 28 of | ≤77284 |
| a third table) | |

For the 5-bit legacy table, the ratio of two nearby BS level in the table is around 0.72 (the former dividing the later) (e.g. for index 27 and index 28, 55474/77284=0.72). If some entries are inserted/added between entries of index 27 and entries of index 28, the ratio of 55474/A1, A1/A2, A2/A3, A3/77284 is larger than 0.72. As a result, the ratio is larger than 0.7. For the 8-bit legacy table, the ratio of two nearby BS level in the table is around 0.94 (the former dividing the later). If some entries are inserted/added between two nearby entries, the ratio is larger than 0.94. As a result, the ratio is larger than 0.9.

The ratios for data amount of two nearby entries in the third 5-bit table are around 0.72. The entries from the X-th to the (X+4)-th of the first table is finer than the entries from 27-th to 28-th of the third 5-bit table. In other word, the ratios for data amount of two nearby entries within the range from X-th entry to the (X+4)-th entry are larger than 0.72, or larger than the minimum ratios in the third 5-bit table, or larger than the maximum ratios in the third 5-bit table, or larger than the average ratios in the third 5-bit table.

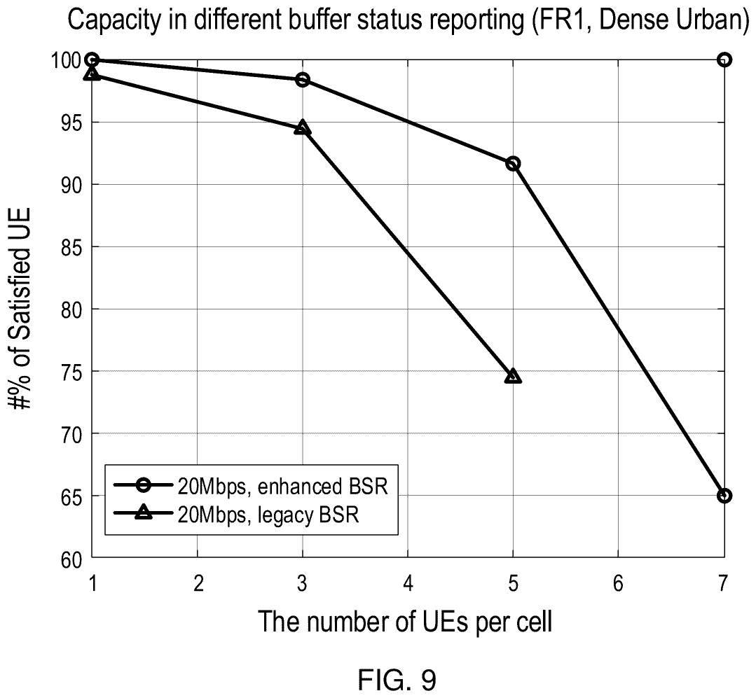

FIG. 9 implies that some entries insert in some of two nearby entries of a third BS level table can improve the capacity performance in video (20 Mbps@60 fps) traffic model. Assuming that BSR signaling is capable of indicating the actual data amount all the time, the capacity would increase dramatically. Maybe the novel table is still not capable of indicating the actual data amount all the time, but the simulation can also illustrate that finer granularity for the new table is no doubt to increase the capacity performance.
3) The data amounts indicated by N−Q−i entries are the rounded results of multiplying the last index of a third table and K, wherein K is larger than 1

For the rest N−Q−i entries, their corresponding data amount is the rounded result of the maximum of the legacy table and K,

| Index | BS level |
|---|---|
| ID1(index 30 in a | ≤150000 |
| third table) | |
| ID2(index 31 in a | ≤A4 |
| third table) | |
| ID2 | ≤A5 |
| ID3 | ≤A6 |
| ID4 | ≤A7 |
| ID5 | ≤NewMax |
| ID6 | >NewMax |

For different Ai, K is different. For example, A4=F(150000*1.5), A5=F(150000*2), A6=F(150000*2.5), A7=F(150000*3) and NewMax=F(150000*3.5). K is 1.5, 2, 2.5, 3, 3.5 for A4, A5, A6, A7, NewMax, respectively. F(x) is any one of flooring, ceiling or rounding operations. In this case, a second table is based on a third table with N total entries including the following features:
a) The total number entries of the second table is P times of that of the third table, where P and N are integers. In some example, P and N are the power of 2.
b) The maximum data amounts of the first M entries of a third table is the maximum data amounts of the first M entries of a second table.
   1) In some cases, the number of entries M is determined by the maximum bearable BS level, which is relevant to:
      I. Modulation order
      II. Frequency domain resource
      III. Time domain resource

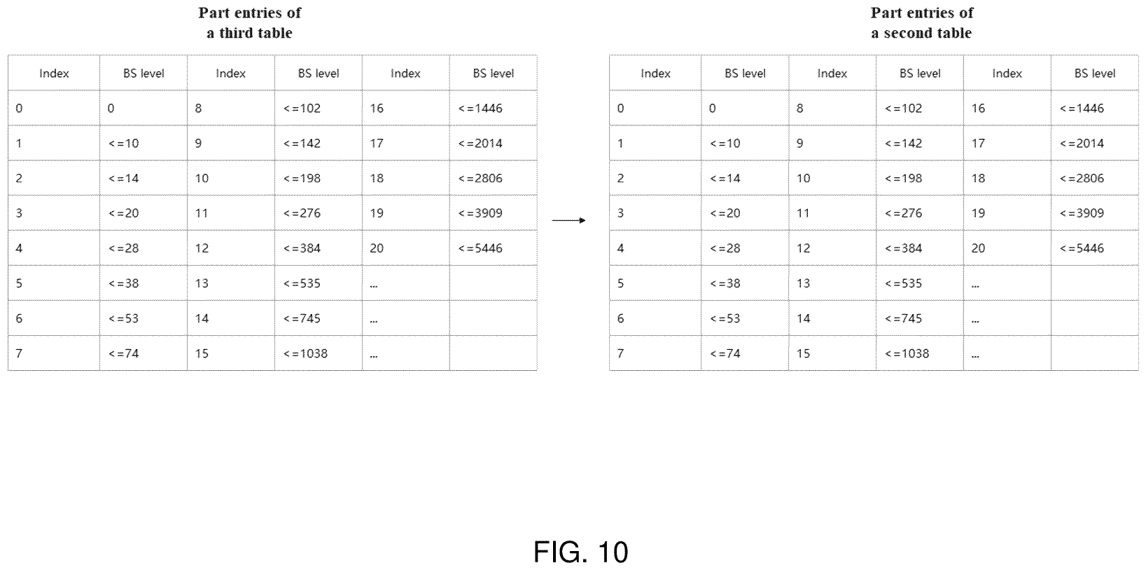

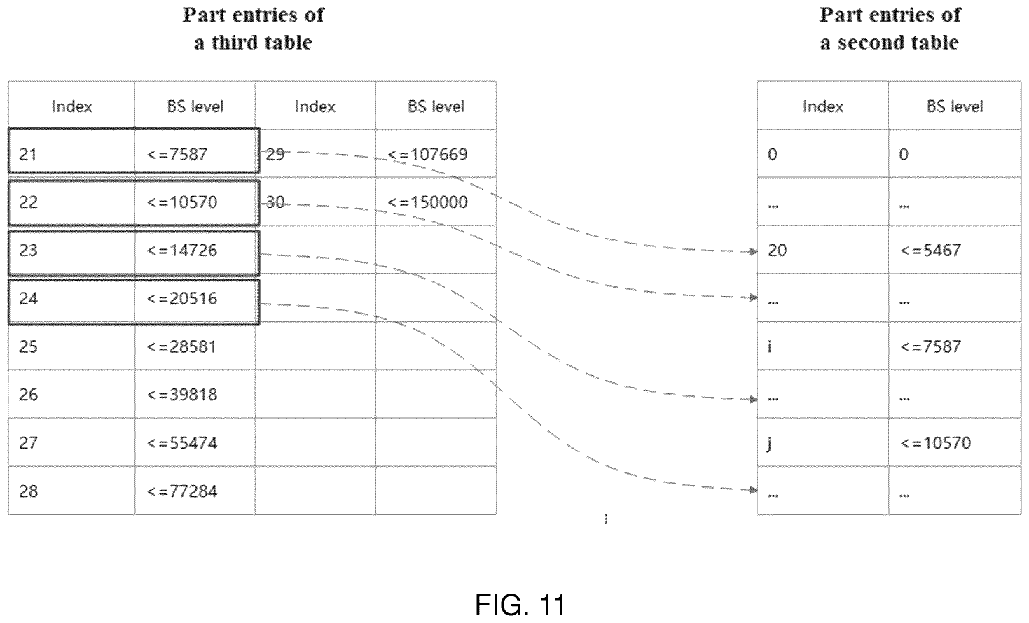

Assuming M=21, the first M entries of a third table is the first M entries of a second table. This step is depicted in FIG. 10.
2) The maximum data amounts of N-M entries of a third table are the maximum data amounts of the entries of a second table, where their indices in a second table are b₁, b₂, . . . , b_{N-M}. This step is depicted in FIG. 11.
3) From the U-th entry to the (U+Q−1) entry of a second table include the following features:
   I. b₁, b₂, . . . , b_{N-M} is within Q entries
   II. L_{1,2} entries are within the entries pair between b₁ and b₂, L_{2,3} entries within the entries pair between b₂ and b₃, and so on, L_{N-M-1,N-M} entries within the entries pair between b_{N-M-1} and b_{N-M}
      a. The sum of L_{1,2}, L_{2,3} . . . and L_{N-M-1,N-M} is Q1, and Q1 is less than Q.
      b. L_{i,j} is relevant to at least one of the following:
         i. Maximum bearable BS level
         ii. The BS level range determined by bᵢ and bⱼ
      c. The ratio between data amounts determined by two nearby entries in N-M+P entries is large than R and less than S.
         i. In some cases, R is larger than 0.7 or R is larger than 0.9.
         ii. In these cases, S is larger than R.

For the 5-bit legacy table, the ratio of two nearby BS level in the table is around 0.72 (the former dividing the later) (e.g. for index 27 and index 28, 55474/77284=0.72). If some entries are inserted/added between entries of index 27 and entries of index 28, the ratio of 55474/A1, A1/A2, A2/A3, A3/77284 is larger than 0.72. As a result, the ratio is larger than 0.7. For the 8-bit legacy table, the ratio of two nearby BS level in the table is around 0.94 (the former dividing the later). If some entries are inserted/added between two nearby entries, the ratio is larger than 0.94. As a result, the ratio is larger than 0.9.

The ratios for data amount of two nearby entries in the third 5-bit table are around 0.72. The entries from the X-th to the (X+4)-th of the first table is finer than the entries from 27-th to 28-th of the third 5-bit table. In other word, the ratios for data amount of two nearby entries within the range from X-th entry to the (X+4)-th entry are larger than 0.72, or larger than the minimum ratios in the third 5-bit table, or larger than the maximum ratios in the third 5-bit table, or larger than the average ratios in the third 5-bit table.
IV. The data amounts indicated by (P−1)*N−Q entries are the results of multiplying the last index of a third table and K, wherein K is larger than 1

For the rest N−Q−i entries, their corresponding data amount is the rounded result of the maximum of the legacy table and K,

| Index | BS level |
|---|---|
| ID1(index 30 in a | ≤150000 |
| third table) | |
| ID2(index 31 in a | ≤A4 |
| third table) | |
| ID2 | ≤A5 |
| ID3 | ≤A6 |
| ID4 | ≤A7 |
| ID5 | ≤NewMax |
| ID6 | >NewMax |

For different Ai, K is different. For example, A4=F(150000*1.5), A5=F(150000*2), A6=F(150000*2.5), A7=F(150000*3) and NewMax=F(150000*3.5). K is 1.5, 2, 2.5, 3, 3.5 for A4, A5, A6, A7, NewMax, respectively. F(x) is any one of flooring, ceiling or rounding operations.

### VII. The Determination of Data Amount of PUSCH

The data amount is determined as at least one of the following:

### (1) The Maximum of the Buffer Size Level Range

Taking 5-bit legacy table for example, the BSR includes the index 26, the UL actual data amount is reported as 39818.
(2) The rounded results of maximum of the buffer size level range multiplying a scaling factor Ti (where the result can be rounded), wherein Ti is larger than 0.7 or is larger than 0.9. And Ti is less than Tmax. In some embodiments, Tmax is less than 1. Ti is one of a plurality of values in the candidate scaling factor in (e.g. scaling factor1) in RRC signaling.

| BSR-Config ::= | SEQUENCE { |
|---|---|
| ... | |
| scalingFactor1 | ENUMERATED{T1,T2,...,Tmax} |

}

| | |
|---|---|
| 25 | ≤28581 |
| 26 | ≤39818 |

Taking the 5-bit legacy table for example, if the actual data volume is 30000 Byte. The index is determined as 26 according to the 5-bit legacy table. If the scalingFactor1 is configured in RRC signaling (both in gNB and UE), we assume that it concludes a set of value, such as {0.75, 0.8, 0.9, 0.95, 0.96, . . . } (see that all the value is larger than 0.72, because 28581/39818=0.72, the 0.72 is the ratio for any nearby entries.) It is obvious that the scaling factor “0.8” is the minimum factor that the multiply results can cover 30000 Byte. [F(0.75*39818)<30000<F(0.8*39818)], where F(x) can be any one of flooring, ceiling or rounding operation. As a result, UE would report the index 26 and the scaling factor index 2 to gNB. Please note that the scaling factor index can be carried by SR signaling mentioned before.
(3) The minimum of the buffer size level range multiplying with Ti (Where the result can be rounded), wherein Ti is less than 1.5 or Ti is less than 1,2, and Ti is larger than Tmin. In some embodiments, Tmin is larger than 1.

Ti is one of a plurality of values in the candidate scaling factor in (e.g. scaling factor1) in RRC signaling.

| BSR-Config ::= | SEQUENCE { |
|---|---|
| ... | |
| scalingFactor1 | ENUMERATED{Tmin,T1,...,Tx} |

}

Taking the 5-bit table for example, if the actual data volume is 30000 Byte. The index is determined as 26 according to the 5-bit legacy table. If the scalingFactor1 is configured in RRC signaling (both in gNB and UE), we assume that it concludes a set of value, such as {1.04, 1.05, 1.11, 1,25, 1.33, . . . } (see that all the value is less than 1.5, because 39818/28581=1.40, the 1.40 is the ratio for almost nearby entries.) It is obvious that the scaling factor “0.8” is the minimum factor that the multiply results can cover 30000 Byte. [F(1.04*28581)<30000<F(1.05*28581)], where F(x) can be any one of flooring, ceiling or rounding operation. As a result, UE would report the index 26 and the scaling factor index 2 to gNB. The scaling factor index can be carried by SR signaling mentioned before, or other UL signaling, such as BSR.

### (4) The Maximum of Buffer Size Level Range Determined by a First BSR or a Second BSR and Delta BSR

For some variable packet traffic, the successive packet size variability is correlated. As a result, the two nearby packet size would not change rapidly. In some embodiments, UE can just transmit some delta information through physical layer signaling, (e.g. SR signaling, or BSR) to gNB for radio resource for PUSCH. In some embodiments, the transmission of delta information is associate with a counter.

Also Taking 5-bit legacy table as an example,

| | |
|---|---|
| 20 | ≤5446 |
| 21 | ≤7587 |
| 22 | ≤10570 |
| 23 | ≤14726 |

If the index for the first data request for grant is index 20, UE is capable of reporting delta information to gNB for the next following data request in a period. For the second data request, if the second data amount for requesting is 10000, the index is corresponding to index 22. In this mechanism, the SR signaling can carry the delta index information “2” (22−20=2) and report to gNB. In gNB side, it should combine previous “index 20” information and the reporting delta index information “2”. And the data mount corresponding to index 22 (20+2) can be informed by gNB.

(5) The rounded result of maximum amount of the table multiplying a scaling factor Wi, when the BSR signaling carries the last index of the table, wherein Wi is a non-negative value. In some embodiments, the Wi is one of a plurality of values in the candidate scaling factor in (e.g. scaling factor2) in RRC signaling and Wi is larger than 1.

| BSR-Config ::= | SEQUENCE { |
|---|---|
| ... | |
| scalingFactor2 | ENUMERATED{W1,W2,...,Wmax} |

}

Taking 5-bit table as an example: if the scalingFactor2 is a set of v={2, 3, 4, 5, . . . }. To further report the data volume larger than maximum of the table, given the candidate scale factor, UE would find the smallest scaling factor Wi as to cover the data volume. If the data volume is 380000, BSR carries the last index of the legacy table. UE would first find 150000*v(1)=150000*2=300000. It is obvious that 300000 BS level does not cover the 380000, and the scaling factor increase based on candidate scaling factor, UE would find 150000*v(2)=150000*3=450000. It seems that 450000 is capable of covering the 380000. As a result, the data volume is reported as 450000. And the index 2 of the scaling factor would be transmitted through physical layer signaling, e.g., SR signaling.

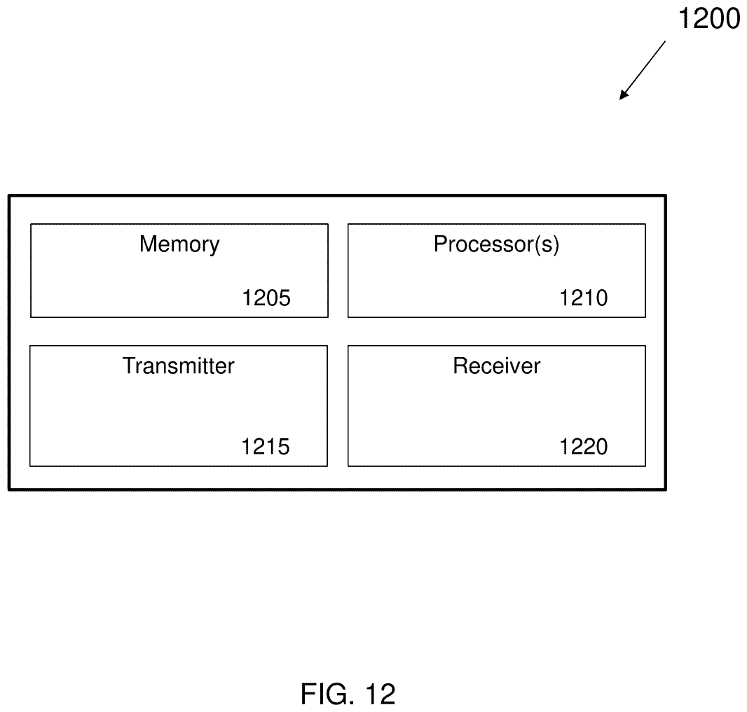

FIG. 12 shows an exemplary block diagram of a hardware platform 1200 that may be a part of a network device (e.g., base station) or a communication device (e.g., a user equipment (UE)). The hardware platform 1000 includes at least one processor 1210 and a memory 1205 having instructions stored thereupon. The instructions upon execution by the processor 1210 configure the hardware platform 1000 to perform the operations described in FIGS. 1A to 11 and 13 to 15 and in the various embodiments described in this patent document. The transmitter 1215 transmits or sends information or data to another device. For example, a network device transmitter can send a message to a user equipment. The receiver 1220 receives information or data transmitted or sent by another device. For example, a user equipment can receive a message from a network device.

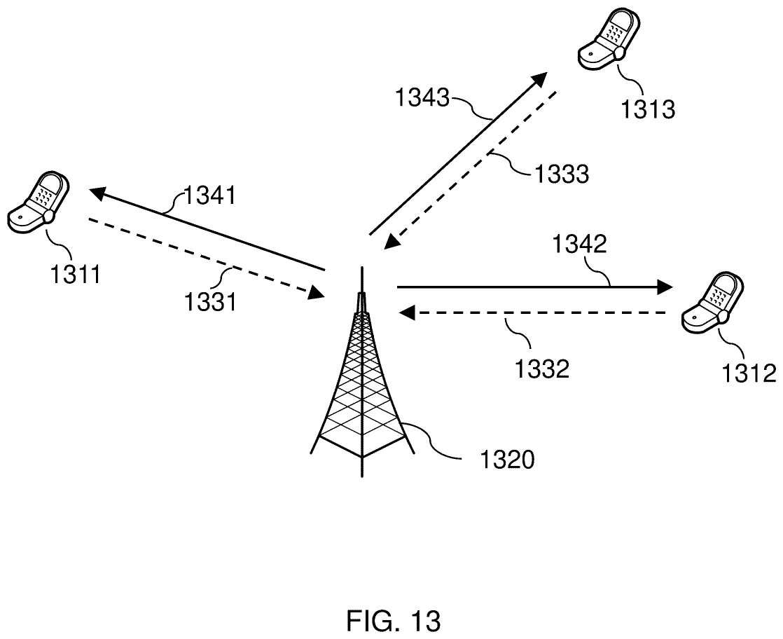

The implementations as discussed above will apply to a wireless communication. FIG. 13 shows an example of a wireless communication system (e.g., a 5G or NR cellular network) that includes a base station 620 and one or more user equipment (UE) 1311, 1312 and 1313. In some embodiments, the UEs access the BS (e.g., the network) using a communication link to the network (sometimes called uplink direction, as depicted by dashed arrows 1331, 1332, 1333), which then enables subsequent communication (e.g., shown in the direction from the network to the UEs, sometimes called downlink direction, shown by arrows 1341, 1342, 1343) from the BS to the UEs. In some embodiments, the BS send information to the UEs (sometimes called downlink direction, as depicted by arrows 1341, 1342, 1343), which then enables subsequent communication (e.g., shown in the direction from the UEs to the BS, sometimes called uplink direction, shown by dashed arrows 1331, 1332, 1333) from the UEs to the BS. The UE may be, for example, a smartphone, a tablet, a mobile computer, a machine to machine (M2M) device, an Internet of Things (IoT) device, and so on.

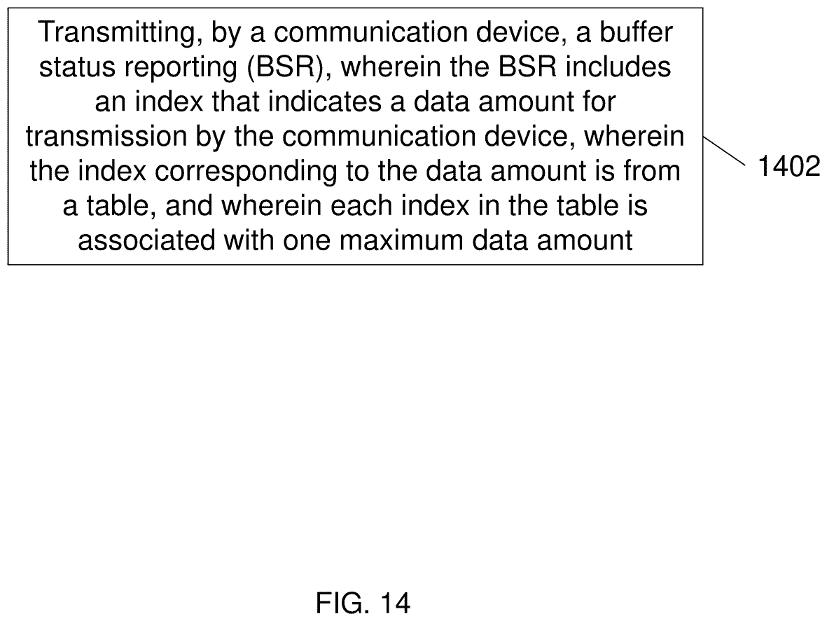

FIG. 14 shows an exemplary flowchart for transmitting a BSR. Operation 1402 includes transmitting, by a communication device, a buffer status reporting (BSR), wherein the BSR includes an index that indicates a data amount for transmission by the communication device, wherein the index corresponding to the data amount is from a table, and wherein each index in the table is associated with one maximum data amount.

In some embodiments, the BSR or the table is determined by a first indication, wherein the first indication is received by the communication device. In some embodiments, the first indication is carried by a radio resource control (RRC) signaling, a medium access control (MAC) control element (CE) signaling, or a physical (PHY) layer signaling. In some embodiments, the PHY layer signaling includes at least a downlink control information (DCI). In some embodiments, the BSR includes a first BSR, or a second BSR. In some embodiments, the first BSR and/or the second BSR is associated with the table.

In some embodiments, the method further comprises transmitting, by a communication device, a second indication wherein the second indication determines or indicates any one or more of: a type of BSR, a table for BSR, a delta index information, or a scaling factor information. In some embodiments, the second indication is carried by a radio resource control (RRC) signaling, a medium access control (MAC) control element (CE) signaling, a MAC CE header, or a physical (PHY) layer signaling. In some embodiments, the RRC signaling includes any one or more of a user equipment (UE) capability, or UE assistance information. In some embodiments, the MAC CE signaling includes an information of a number of logical channels or a BSR. In some embodiments, the MAC CE header includes any one or more of a logical channel identifier (LCID), an enhanced logical channel identifier (eLCID) in a subheader of MAC protocol data unit (PDU), a reserved bit, or an extended Oct bits in subheader of MAC PDU.

In some embodiments, the PHY layer signaling includes a scheduling request (SR) signaling. In some embodiments, information carried by the SR is determined by a PUCCH format, a predefined time and frequency transmission resource, a sequence, and/or code-point. In some embodiments, the second indication is valid within a first time duration, wherein the time duration is determined by a first timer. In some embodiments, the second indication is not transmitted within a second time duration, wherein the second time duration is determined by a second timer. In some embodiments, an ending time of the first time duration is configured by RRC signaling. In some embodiments, a start time of the first time duration is determined by a slot offset, and/or a symbol offset. In some embodiments, an ending time of the second time duration is configured by RRC signaling. In some embodiments, a start time of the second time duration is determined by a slot offset, and/or symbol offset. In some embodiments, the second indication includes the delta index information or the scaling factor information, wherein a transmission of the second indication is associated with a counter.

In some embodiments, the counter includes any one or more of the following characteristics: (1) the counter increases or decrements after the transmission of the second indication, and (2) the counter is reset in response to the transmitting the BSR. In some embodiments, the table includes a first table, a second table or a third table, wherein at least one of the first table or the second table is associated with a third table. In some embodiments, the table is the first table, wherein the table includes N total number of entries where N is an integer and is power of 2. In some embodiments, the maximum data amount of a M-th entry of a third table is that of an i-th entry of the first table, wherein 0<i<M, wherein M<N, and wherein M and i are integers. In some embodiments, the maximum data amounts of last N-M entries of a third table are that of entries of the first table, a ratio of data amount in two nearby entries, a former data amount dividing the later data amount, from a U-th entry to a (U+Q−1)-th entry of the first table is larger than S and less than R, S is less than 0.7 or 0.9, and R is less than 1, and where N−M<Q<N, i<U<N, and U is an integer. In some embodiments, the granularity from the U-th entry to the (U+Q−1)-th entry of the first table is finer than a W-th entry to a (W+T−1)-th entry of the third table, wherein W and T are integers, and 0<W<N−T, T<N.

In some embodiments, a data amount of any one of the last N−Q−i entries of the first table is K times of a maximum of a third table, respectively, wherein K is larger than 1. In some embodiments, the table is the second table, wherein the table includes P times of N total number of entries where P and N are integers and are the power of 2. In some embodiments, the maximum data amount of N entries of a third table is that of the entries of a second table. In some embodiments, a ratio of data amount in two nearby entries, a former data amount dividing the later data amount, from a U-th entry to a (U+Q−1)-th entry of the second table is larger than S and less than R, and S is less than 0.7 or 0.9, and R is less than 1, where 1<U<P*N, 1<Q<P*N, where Q and U are integers. In some embodiments, the granularity from U-th entry to (U+Q−1)-th entry of the second table is finer than the W-th entry to the (W+T−1)-th entry of the third table, wherein W and T are integers, and 0<W<N−T, T<N.

In some embodiments, a data amount of any one of the last (P−1)*N−Q entries of a second table is K times of the maximum of a third table, wherein K is larger than 1. In some embodiments, the data amount is indicated by the index including any one or more of the following: (1) a corresponding maximum data amount indicated by the index is the data amount, (2) a rounded result of corresponding maximum data amount indicated by the index multiplying a scaling factor determined by the second indication is the data amount, (3) the rounded result of corresponding minimum data amount indicated by the index multiplying a scaling factor determined by the second indication is the data amount, and (4) the rounded result of corresponding maximum data amount of the table multiplying a scaling factor determined by the second indication is the data amount, wherein the rounded result is a result of flooring, ceiling, or rounding. In some embodiments, the scaling factor is one of a plurality of values in candidate scaling factor determined by at least one of the following: RRC signaling, MAC CE signaling. In some embodiments, the data amount is determined by the rounded result of corresponding maximum data amount multiplying a scaling factor, the scaling factor is larger than 0.7 or 0.9, and less than 1.

In some embodiments, the data amount is determined by the rounded result of corresponding minimum data amount multiplying a scaling factor, the scaling factor is larger than 1, and less than 1.5 or 1,2. In some embodiments, the data amount is determined by the rounded result of corresponding maximum data amount of the table multiplying a scaling factor, the scaling factor is larger than 1.

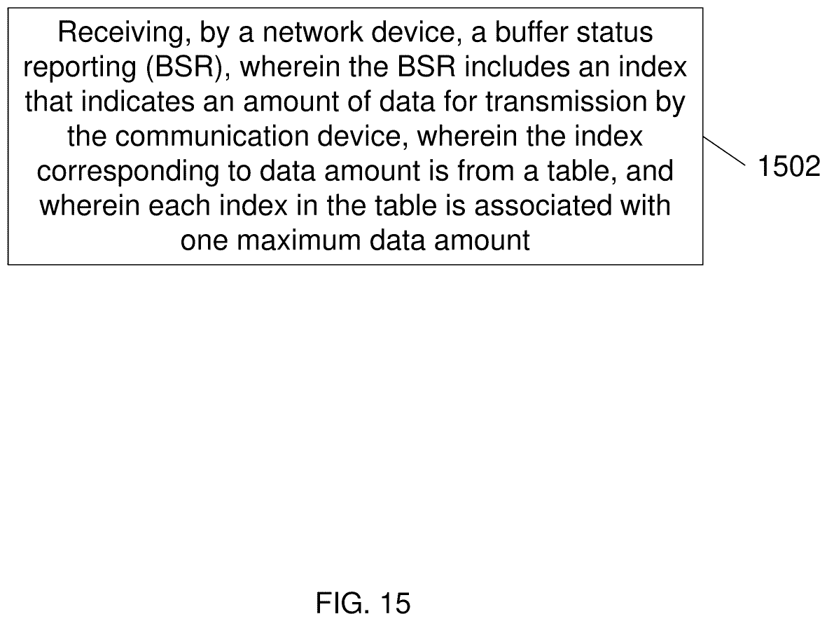

FIG. 15 shows an exemplary flowchart for receiving a BSR. Operation 1502 includes receiving, by a network device, a buffer status reporting (BSR), wherein the BSR includes an index that indicates an amount of data for transmission by the communication device, wherein the index corresponding to data amount is from a table, and wherein each index in the table is associated with one maximum data amount.

In some embodiments, the BSR or the table is determined by a first indication, wherein the first indication is transmitted from the network device. In some embodiments, the first indication is carried by a RRC signaling, a MAC CE signaling, or a PHY layer signaling. In some embodiments, the PHY layer signaling includes at least a downlink control information (DCI). In some embodiments, the BSR includes a first BSR, or a second BSR. In some embodiments, the first BSR and/or the second BSR is associated with the table. In some embodiments, the method further includes receiving, by a network device, a second indication, wherein the second indication includes any one or more of: a type of BSR, a table for BSR, a delta index information, or a scaling factor information. In some embodiments, the second indication is carried by a RRC signaling, a MAC CE signaling, a MAC CE header, or a PHY layer signaling.

In some embodiments, the RRC signaling includes any one or more of a UE capability, or UE assistance information. In some embodiments, the MAC CE signaling includes an information of a number of logical channels, or a BSR. In some embodiments, the MAC CE header includes any one or more of a LCID, an eLCID in a subheader of a MAC PDU, a reserved bit, or an extended Oct bits in subheader of MAC PDU. In some embodiments, the PHY layer signaling includes a SR signaling. In some embodiments, information carried by the SR is determined by a PUCCH format, a predefined time and frequency transmission resource, a sequence, and/or code-point.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
transmitting, by a communication device, a buffer status reporting (BSR) and a second indication that indicates a selection of a table for the BSR,
wherein the BSR includes an index that indicates a data amount for transmission by the communication device,
wherein the index corresponding to the data amount is from the table, and
wherein each index in the table is associated with one maximum data amount,
wherein the table is selected between a first table and a third table, and
wherein a granularity of the first table is finer than that of the third table.

2. The method of claim 1, wherein the table is determined by a first indication, wherein the first indication is received by the communication device.

3. The method of claim 1, wherein the second indication is carried by a medium access control (MAC) control element (CE) signaling.

4. The method of claim 3, wherein the MAC CE signaling includes an information of a number of logical channels or the BSR.

5. The method of claim 1, wherein the table is the first table, wherein the table includes N total number of entries where N is an integer and is power of 2.

6. The method of claim 5, wherein the maximum data amount of a M-th entry of a third table is that of an i-th entry of the first table, wherein 0<i<M, wherein M<N, and wherein M and i are integers.

7. The method of claim 5,
wherein a ratio of data amount in two nearby entries, a former data amount divided by a later data amount, from a U-th entry to a (U+Q−1)-th entry of the first table is larger than S and less than R,
wherein S is less than 0.7 or 0.9, and R is less than 1, and
where N−M<Q<N, i<U<N, and U is an integer.

8. The method of claim 5, wherein a granularity from a U-th entry to a (U+Q−1)-th entry of the first table is finer than a W-th entry to a (W+T−1)-th entry of the third table, wherein W and T are integers, and 0<W<N−T, T<N.

9. A communication device for wireless communication comprising a processor, configured to implement a method that causes the communication device to:
transmit a buffer status reporting (BSR) and a second indication that indicates a selection of a table for the BSR,
wherein the BSR includes an index that indicates a data amount for transmission by the communication device,
wherein the index corresponding to the data amount is from the table,
wherein each index in the table is associated with one maximum data amount,
wherein the table is selected between a first table and a third table, and
wherein a granularity of the first table is finer than that of the third table.

10. The communication device of claim 9, wherein the table is determined by a first indication, wherein the first indication is received by the communication device.

11. The communication device of claim 9, wherein the second indication is carried by a medium access control (MAC) control element (CE) signaling.

12. The communication device of claim 11, wherein the MAC CE signaling includes an information of a number of logical channels or the BSR.

13. The communication device of claim 9, wherein the table is the first table, wherein the table includes N total number of entries where N is an integer and is power of 2.

14. The communication device of claim 13, wherein the maximum data amount of a M-th entry of a third table is that of an i-th entry of the first table, wherein 0<i<M, wherein M<N, and wherein M and i are integers.

15. The communication device of claim 13,
wherein a ratio of data amount in two nearby entries, a former data amount divided by a later data amount, from a U-th entry to a (U+Q−1)-th entry of the first table is larger than S and less than R,
wherein S is less than 0.7 or 0.9, and R is less than 1, and
where N−M<Q<N, i<U<N, and U is an integer.

16. The communication device of claim 13, wherein a granularity from a U-th entry to a (U+Q−1)-th entry of the first table is finer than a W-th entry to a (W+T−1)-th entry of the third table, wherein W and T are integers, and 0<W<N−T, T<N.

17. A non-transitory computer readable program storage medium having code stored thereon, the code, when executed by a processor, causing the processor to implement a method, comprising:
transmitting, by a communication device, a buffer status reporting (BSR) and a second indication that indicates a selection of a table for the BSR,
wherein the BSR includes an index that indicates a data amount for transmission by the communication device,
wherein the index corresponding to the data amount is from the table,
wherein each index in the table is associated with one maximum data amount,
wherein the table is selected between a first table and a third table, and
wherein a granularity of the first table is finer than that of the third table.

18. The non-transitory computer readable program storage medium of claim 17, wherein the table is determined by a first indication, wherein the first indication is received by the communication device.

19. The non-transitory computer readable program storage medium of claim 17, wherein the second indication is carried by a medium access control (MAC) control element (CE) signaling.

20. The non-transitory computer readable program storage medium of claim 19, wherein the MAC CE signaling includes an information of a number of logical channels or the BSR.
